(19) United States
(12) Patent Application Publication
(10) Pub. No.: US 2007/0293625 A1
(43) Pub. Date: Dec. 20, 2007

(54) New polyurethanes and their use for thickening aqueous systems

(75) Inventors: Frank Sauer, Langenfeld (DE); Dietmar Helker, Langenfeld (DE); Anja Sonntag, Langenfeld (DE); Claudia Menzel, Hilden (DE); Peter Manshausen, Koln (DE)

Correspondence Address: LANXESS CORPORATION, 111 RIDC PARK WEST DRIVE, PITTSBURGH, PA, 15275-1112, US

(73) Assignee: Borchers GmbH

(21) Appl. No.: 11/811,128

(22) Filed: Jun. 8, 2007

(30) Foreign Application Priority Data
Jun. 14, 2006 (DE) 10 2006 027 490.3

(51) Int. Cl. C08G 18/00; C08G 18/08

(52) U.S. Cl. 524/589; 528/44

(57) ABSTRACT

The invention relates to new, hydrophilic/hydrophobic, water-soluble or water-dispersible polyurethanes, suitable as thickeners for aqueous systems, which are distinguished by a particularly efficient thickening effect in the low-shear range, and also to their use for thickening aqueous systems.

The invention relates to new, hydrophilic/hydrophobic, water-soluble or water-dispersible polyurethanes, suitable as thickeners for aqueous systems, which are distinguished by a particularly efficient thickening effect in the low-shear range, and also to their use for thickening aqueous systems.

Polyurethane-based thickeners for aqueous systems are described in numerous publications (cf. e.g. DE-A 1 444 243, DE-A 3 630 319, EP-A 0 031 777, EP-A 0 307 775, EP-A 0 495 373, U.S. Pat. No. 4,079,028, U.S. Pat. No. 4,155,892, U.S. Pat. No. 4,499,233 or U.S. Pat. No. 5,023,309). Polyurethane thickeners are also known from EP-A-618 243, 725 097, 839 877 and 1 241 200.

A common feature of these prior-art thickeners is the simultaneous presence of (i) hydrophilic segments, in an amount of at least 50% by weight, (ii) hydrophobic segments in an amount of not more than 30% by weight, and (iii) urethane groups. By “hydrophilic segments” are meant here, in particular, polyether chains having at least 5 chain members, at least 50 mol % of whose alkylene oxide units are composed of ethylene oxide units. By “hydrophobic segments” are meant here, in particular, hydrocarbon segments which are preferably incorporated terminally and have at least 6 carbon atoms.

The thickeners of the invention, described in greater detail below, also correspond preferably to this definition.

These polyurethane thickeners are suitable auxiliaries for adjusting rheological properties of aqueous systems such as, for example, automotive and industrial coatings, coloured renders and paints, inks for printing and for textiles, pigment printing pastes, pharmaceutical and cosmetic preparations, crop protection formulations, laundry detergent preparations or dispersions of filler or of adhesive.

In spite of the broad application of the known polyurethane thickeners, there are numerous fields of use in which their thickening effect in the low-shear range is too low. Consequently, either they must be used at comparatively high concentrations, or else other measures must be taken in order to increase the viscosity, such as increasing the pigment concentration or solids concentration, for example. In such cases, however, there may be unwanted alterations to the performance properties, such as the levelling, the curing behaviour, the gloss or the hiding power, of the inks, paints or other preparations that are produced.

Another way of efficiently increasing the low-shear viscosity is to use thickeners based on cellulose or polyacrylates. These products, however, have other serious drawbacks, such as reduced compatibility in coating, poor water resistance, susceptibility to microorganisms, or relatively poor levelling and gloss, for example.

The object of the present invention, then, was to develop improved thickeners for aqueous systems for application in the low-shear range that have a high rheological efficiency similar to that of the aforementioned cellulose compounds or polyacrylates, but which do not exhibit the drawbacks specified.

It has now surprisingly proved possible to achieve this object, with the provision of the hydrophilic/hydrophobic, water-soluble or water-dispersible polyurethanes of the invention, described below in greater detail. Essential to the invention in this case is the use of “hydrophobic segments”, in particular of hydrocarbon segments having at least 6 carbon atoms and having at least 1 unsaturated structural element (carbon-carbon double bond).

The invention provides water-soluble or water-dispersible polyurethanes prepared in a one-stage or multi-stage reaction, subject to an NCO/OH equivalent ratio of 0.5:1 to 1.2:1, from
A) at least one polyetherpolyol of average functionality≧1.2,
B) at least one (cyclo)aliphatic and/or aromatic diisocyanate,
C) at least one linear or branched, (cyclo)aliphatic monoalcohol having 6 to 34 carbon atoms and at least one unsaturated structural element (carbon-carbon double bond) as an integral constituent or at least one linear or branched, (cyclo)aliphatic monoalcohol alkoxylate having 6 to 34 carbon atoms, at least one unsaturated structural element (carbon-carbon double bond) as an integral constituent, and having been extended by at least one ethylene oxide (EO) or propylene oxide (PO) unit, or aromatic monoalcohols and/or aromatic monoalcohol alkoxylates having 6 to 34 carbon atoms, or mixtures of these components,
D) where appropriate, a further linear or branched monofunctional component having a carbon radical of 6 to 34 carbon atoms which is able to react with isocyanates and which is preferably composed of a (cyclo)aliphatic and/or aromatic monoalcohol, a (cyclo)aliphatic and/or aromatic monoalcohol alkoxylate or a (cyclo)aliphatic and/or aromatic amine. Component D) is preferably saturated.

The invention further provides a process for preparing water-soluble or water-dispersible polyurethanes prepared, subject to an NCO/OH equivalent ratio of 0.5:1 to 1.2:1, in a one-stage or multi-stage reaction from
A) at least one polyetherpolyol of average functionality≧1.2,
B) at least one (cyclo)aliphatic and/or aromatic diisocyanate,
C) at least one linear or branched, (cyclo)aliphatic monoalcohol having 6 to 34 carbon atoms and at least one unsaturated structural element (carbon-carbon double bond) as an integral constituent or at least one linear or branched, (cyclo)aliphatic monoalcohol alkoxylate having 6 to 34 carbon atoms, at least one unsaturated structural element (carbon-carbon double bond) as an integral constituent, and having been extended by at least one ethylene oxide (EO) or propylene oxide (PO) unit, or aromatic monoalcohols and/or aromatic monoalcohol alkoxylates having 6 to 34 carbon atoms, or mixtures of these two components,
D) where appropriate, a further linear or branched monofunctional component having a carbon radical of 6 to 34 carbon atoms which can be linked covalently to isocyanates and which is preferably composed of a (cyclo)aliphatic and/or aromatic monoalcohol, a (cyclo)aliphatic and/or aromatic monoalcohol alkoxylate or a (cyclo)aliphatic and/or aromatic amine.

The invention additionally provides for the use of the polyurethanes of the invention for thickening aqueous systems.

The polyetherpolyol component A) is preferably composed of a compound of the general formula (I)
R₁[—O-(A)ₓ-H]_{y} (I),
where
R₁ is an aliphatic or araliphatic hydrocarbon radical having 2 to 36 carbon atoms, containing ether oxygen atoms where appropriate,
A is ethylene oxide and/or propylene oxide radicals, with the proviso that at least 50 mol %, preferably 70 mol % and more preferably 100 mol % of the radicals are ethylene oxide radicals,
x is a number from 20 to 300 and
y is a number from 1 to 6, preferably 2 to 6.

The average functionality of component A is preferably greater than or equal to 2, in a further embodiment approximately 2, and in another embodiment 3 to 4.

Component B) is preferably composed of at least one diisocyanate of the general formula (II)
OCN—R₂—NCO (II),
in which
R₂ is an aliphatic, araliphatic, cycloaliphatic or aromatic radical having 4 to 22 carbon atoms which where appropriate contains inert substituents.

Examples of diisocyanates of components B) are aliphatic diisocyanates such as 1,4-butane diisocyanate or 1,6-hexane diisocyanate; cycloaliphatic diisocyanates such as 1-isocyanato-3,3,5-trimethyl-5-isocyanatomethylcyclohexane (isophorone diisocyanate), 1,3- and 1,4-cyclohexane diisocyanate, 4,4′-diisocyanatodicyclohexylmethane, etc., and also aromatic diisocyanates such as 2,4-diisocyanatotoluene and 4,4′-diisocyanatodiphenylmethane, for example.

Component C) is preferably composed of at least one component, containing a hydroxyl group, of the general formula (III)
R₃—O-(A)ₙ-H (III),
in which
R₃ is a linear or branched aliphatic, araliphatic, cycloaliphatic or aromatic radical having 6 to 34 carbon atoms which has at least one unsaturated structural element (carbon-carbon double bond) as an integral constituent.
A is ethylene oxide and/or propylene oxide radicals.
n is a number from 0 to 1000.

Examples of component C) are unsaturated (cyclo)aliphatic alcohols such as 1-octenol, 2-ethylhexenol, 1-nonenol, 1-decenol, 1-dodecenol, 1-tetradecenol, 1-hexadecenol, 1-octadecenol, 1-docosenol and their alkoxylated variants, or aromatic alcohols such as aryl polyglycol ethers, 2-hydroxybiphenylyl ether or 4-hydroxybiphenylyl ether or retinol.

Preference is given to unsaturated or aromatic monoalcohols having 10 to 24 carbon atoms, particular preference to unsaturated or aromatic monoalcohols having 14 to 20 carbon atoms. It will be appreciated that mixtures of the exemplified components C) can also be used.

Monofunctional component D), whose use is optional, is composed preferably of at least one component of the general formula (IV) or of at least one component of the general formula (V)
R₄—O-(A)ₚ-H (IV)
R₄—X (V),
or else of mixtures of the two specified components,
in which
R₄ is a linear or branched aliphatic, araliphatic, cycloaliphatic or aromatic radical having 6 to 34 carbon atoms.
A is ethylene oxide and/or propylene oxide radicals.
p is a number from 1 to 20.
X is a functional group which can be linked covalently to isocyanates and which is preferably composed of a hydroxyl group (—OH) or an amine group (—NH₂).

Examples of component D) are (cyclo)aliphatic alcohols such as 1-octanol, 2-ethylhexanol, 1-nonanol, 1-decanol, 1-dodecanol, 1-tetradecanol, 1-hexadecanol, 1-octadecanol, 1-docosanol and their alkoxylated variants or else 1-octylamine, 1-decylamine, 1-dodecylamine, ditridecylamine (isomer mixture), etc. Preference is given to monoalcohols having 8 to 24 carbon atoms, particular preference to monoalcohols having 10 to 18 carbon atoms. It will be appreciated that mixtures of the exemplified components D) can also be used.

The polyurethanes of the invention are prepared in one stage or a multiplicity of stages. By a one-stage reaction is meant in this context the reaction of the entirety of component A) with the entirety of components B), C) and, where used, D). A multi-stage reaction consists, for example, in the reaction of the polyether A) with the diisocyanate B) and in a subsequent reaction of this precursor with the entirety of component C) and, where used, of component D). A multi-stage reaction may likewise or additionally consist in a separate reaction of part or the entirety of the components C) with a molar excess of diisocyanate component B) and subsequent reaction of the resultant NCO prepolymer with component A) and, where appropriate, component D). In this case the sequence of the reactions is largely unimportant; all that need be done, however, is to ensure that the quantities of components A) to C) and, where used, D) employed are such that a polymerization product in accordance with the definition stated above can be formed.

The polyurethanes of the invention that are prepared in this way are generally colourless to yellowish waxes or high-viscosity polymers having softening points or softening ranges within the temperature range from 10 to 100° C. For the purpose of subsequent use it is often advantageous to mix the polyurethanes of the invention with adjuvants, such as formulating agents, solvents, water, emulsifiers or stabilizers, for example, to form liquid formulations.

The polyurethanes of the invention are suitable for thickening aqueous or predominantly aqueous systems such as varnishes, inks, paints, leather assistants, papermaking assistants, crude oil extraction preparations, laundry detergent preparations, adhesives, waxes for polishes, formulations for pharmaceutical and veterinary use, crop protection preparations, cosmetics articles, etc. The water itself can also be thickened with the polyurethane thickeners of the invention, before then being admixed, if desired, with further adjuvants or being itself added to aqueous preparations. The thickeners of the invention can also be used in mixtures with other thickeners, such as those based on polyurethanes, polyacrylates, cellulose derivatives or inorganic thickeners. In one preferred embodiment the systems of the invention comprise 5% to 70% water, in particular 10% to 50% water.

Examples of aqueous systems which can be thickened in accordance with the invention are aqueous polyacrylate dispersions, aqueous dispersions of copolymers of olefinically unsaturated monomers, aqueous polyvinyl acetate dispersions, aqueous polyurethane dispersions, aqueous polyester dispersions and, in particular, ready-to-use preparations of the type already discussed above that are based on such dispersions or mixtures of such dispersions.

The thickeners of the invention can of course be used in bulk, preferably as granules or, where appropriate, powders. Finding particularly preferred use, however, are liquid formulations which as well as the polyurethanes of the invention comprise water, solvents such as butyl glycol, butyl diglycol, butyl triglycol, isopropanol, methoxypropyl acetate, ethylene glycol and/or propylene glycol, (poly)ethylene and/or (poly)propylene glycol monoalkyl ethers, nonionic emulsifiers, surfactants and/or, where appropriate, further additives, since this makes the thickeners of the invention significantly easier to incorporate into aqueous or predominantly aqueous systems.

With particular preference the ready-to-use preparations of the thickeners of the invention are aqueous solutions or dispersions having a solids content of 10% to 80%, preferably 20% to 60% and more preferably 25% to 50% by weight.

The amount of thickeners of the invention added to the aqueous or predominantly aqueous systems in order to achieve the desired thickening depends on the particular end use and may be determined by the skilled person in a few tests. Generally speaking, 0.05% to 10%, preferably 0.1 to 4%, more preferably 0.1% to 2% by weight of the thickener of the invention is used, these percentages being based on the fully formulated thickener of the invention in the as-supplied form.

The activity of the thickeners of the invention can be assessed by known methods, as for example in a Haake rotational viscometer, in a Stormer viscometer or in a Brookfield viscometer.

### EXAMPLES

Abbreviations:

DBTL: dibutyltin(IV) dilaurate

Borchi® Kat 24: bismuth(III) octoate

Borchi® Kat 28: tin(II) octoate

### Base Materials Employed

Polyetherpolyol A:

I Polyether based on glycerol and ethylene oxide, with an OH number of 16.3 mg KOH/g
Ia Polyether based on glycerol and ethylene oxide/propylene oxide, with an OH number of 16.8 mg KOH/g
II Polyether based on ethylene glycol and ethylene oxide, with an OH number of 9.4 mg KOH/g
III Polyether based on ethylene glycol and ethylene oxide, with an OH number of 14.0 mg KOH/g
IV Polyether based on ethylene glycol and ethylene oxide, with an OH number of 28.0 mg KOH/g
V Polyester based on pentaerythritol, with an OH number of 18.7 mg KOH/g

### Preparation of the Inventive Polyurethanes

### Example 1

180 g of polyether II were weighed out under nitrogen into a 1 l glass flask and freed from traces of water by introduction of a stream of nitrogen at 110-115° C. for 1.5-2 hours. This initial charge is cooled to 90° C., admixed with 10.58 g of ethoxylated oleyl-cetyl alcohol (OH number: 165 mg KOH/g) and dewatered under a stream of nitrogen for a further half an hour. It is then admixed at 90-95° C. with 0.24 g of Borchi® Kat 24 (BORCHERS GmbH) and 7.50 g of Desmodur® 44 MC (Bayer AG). It is stirred at 90-95° C. until an isocyanate band is no longer detectable by IR spectroscopy. This gave a highly viscous polyurethane resin pale yellowish in colour.

### Example 2

150 g of polyether IV were weighed out under nitrogen into a 1 l glass flask and freed from traces of water by introduction of a stream of nitrogen at 110-115° C. for 1.5-2 hours. This initial charge is cooled to 90° C., admixed with 13.51 g of ethoxylated oleyl-cetyl alcohol (OH number: 154.2 mg KOH/g) and dewatered under a stream of nitrogen for a further half an hour. It is then admixed at 90-95° C. with 0.27 g of Borchi® Kat 24 (BORCHERS GmbH) and 14.74 g of Desmodur® W/1 (Bayer AG). It is stirred at 90-95° C. until an isocyanate band is no longer detectable by IR spectroscopy. This gave a highly viscous polyurethane resin pale yellowish in colour.

### Example 3

150 g of polyether I were weighed out under nitrogen into a 1 l glass flask and freed from traces of water by introduction of a stream of nitrogen at 110-115° C. for 1.5-2 hours. This initial charge is cooled to 90° C., admixed with 19.85 g of ethoxylated oleyl-cetyl alcohol (OH number: 165 mg KOH/g) and dewatered under a stream of nitrogen for a further half an hour. It is then admixed at 90-95° C. with 0.25 g of Borchi® Kat 24 (BORCHERS GmbH) and 8.99 g of Desmodur® I (Bayer AG). It is stirred at 90-95° C. until an isocyanate band is no longer detectable by IR spectroscopy. This gave a highly viscous polyurethane resin pale yellowish in colour.

### Example 4

150 g of polyether III were weighed out under nitrogen into a 1 l glass flask and freed from traces of water by introduction of a stream of nitrogen at 110-115° C. for 1.5-2 hours. This initial charge is cooled to 90° C., admixed with 13.23 g of ethoxylated oleyl-cetyl alcohol (OH number: 165 mg KOH/g) and dewatered under a stream of nitrogen for a further half an hour. It is then admixed at 90-95° C. with 0.25 g of Borchi® Kat 24 (BORCHERS GmbH) and 9.83 g of Desmodur® W/1 (Bayer AG). It is stirred at 90-95° C. until an isocyanate band is no longer detectable by IR spectroscopy. This gave a highly viscous polyurethane resin pale yellowish in colour.

### Example 5

150 g of polyether III were weighed out under nitrogen into a 1 l glass flask and freed from traces of water by introduction of a stream of nitrogen at 110-115° C. for 1.5-2 hours. This initial charge is cooled to 90° C., admixed with 10.07 g of ethoxylated oleyl-cetyl alcohol (OH number: 210 mg KOH/g) and dewatered under a stream of nitrogen for a further half an hour. It is then admixed at 90-95° C. with 0.25 g of Borchi® Kat 24 (BORCHERS GmbH) and 9.83 g of Desmodur® W/1 (Bayer AG). It is stirred at 90-95° C. until an isocyanate band is no longer detectable by IR spectroscopy. This gave a highly viscous polyurethane resin pale yellowish in colour.

### Example 6

150 g of polyether I were weighed out under nitrogen into a 1 l glass flask and freed from traces of water by introduction of a stream of nitrogen at 110-115° C. for 1.5-2 hours. This initial charge is cooled to 90° C., admixed with 15.01 g of ethoxylated oleyl-cetyl alcohol (OH number: 210 mg KOH/g) and dewatered under a stream of nitrogen for a further half an hour. It is then admixed at 90-95° C. with 0.25 g of Borchi® Kat 24 (BORCHERS GmbH) and 8.99 g of Desmodur® I (Bayer AG). It is stirred at 90-95° C. until an isocyanate band is no longer detectable by IR spectroscopy. This gave a highly viscous polyurethane resin pale yellowish in colour.

### Example 7

150 g of polyether I were weighed out under nitrogen into a 1 l glass flask and freed from traces of water by introduction of a stream of nitrogen at 110-115° C. for 1.5-2 hours. This initial charge is cooled to 90° C., admixed with 20.27 g of ethoxylated oleyl-cetyl alcohol (OH number: 154.2 mg KOH/g) and dewatered under a stream of nitrogen for a further half an hour. It is then admixed at 90-95° C. with 0.25 g of Borchi® Kat 24 (BORCHERS GmbH) and 8.99 g of Desmodur® I (Bayer AG). It is stirred at 90-95° C. until an isocyanate band is no longer detectable by IR spectroscopy. This gave a highly viscous polyurethane resin pale yellowish in colour.

### Example 8

150 g of polyether III were weighed out under nitrogen into a 1 l glass flask and freed from traces of water by introduction of a stream of nitrogen at 110-115° C. for 1.5-2 hours. This initial charge is cooled to 90° C., admixed with 13.51 g of ethoxylated oleyl-cetyl alcohol (OH number: 154.2 mg KOH/g) and dewatered under a stream of nitrogen for a further half an hour. It is then admixed at 90-95° C. with 0.25 g of Borchi® Kat 24 (BORCHERS GmbH) and 9.83 g of Desmodur® W/1 (Bayer AG). It is stirred at 90-95° C. until an isocyanate band is no longer detectable by IR spectroscopy. This gave a highly viscous polyurethane resin pale yellowish in colour.

### Example 9

300 g of polyether III were weighed out under nitrogen into a 1 l glass flask and freed from traces of water by introduction of a stream of nitrogen at 110-115° C. for 1.5-2 hours. This initial charge is cooled to 90° C., admixed with 13.51 g of ethoxylated oleyl-cetyl alcohol (OH number: 154.2 mg KOH/g) and dewatered under a stream of nitrogen for a further half an hour. It is then admixed at 90-95° C. with 0.25 g of Borchi® Kat 24 (BORCHERS GmbH) and 14.74 g of Desmodur® W/1 (Bayer AG). It is stirred at 90-95° C. until an isocyanate band is no longer detectable by IR spectroscopy. This gave a highly viscous polyurethane resin pale yellowish in colour.

### Example 10

200 g of polyether I were weighed out under nitrogen into a 1 l glass flask and freed from traces of water by introduction of a stream of nitrogen at 110-115° C. for 1.5-2 hours. This initial charge is cooled to 90° C., admixed with 46.57 g of aryl polyglycol ether (OH number: 102 mg KOH/g) and dewatered under a stream of nitrogen for a further half an hour.

It is then admixed at 90-95° C. with 0.24 g of Borchi® Kat 28 (borchers GmbH) and 15.97 g of Desmodur® W/1 (Bayer AG). It is stirred at 90-95° C. until an isocyanate band is no longer detectable by IR spectroscopy. This gave a highly viscous polyurethane resin pale yellowish in colour.

### Example 11

180 g of polyether Ia were weighed out under nitrogen into a 1 l glass flask and freed from traces of water by introduction of a stream of nitrogen at 110-115° C. for 1.5-2 hours. This initial charge is cooled to 90° C., admixed with 20.83 g of oleyl-cetyl alcohol (OH number: 181.50 mg KOH/g) and dewatered under a stream of nitrogen for a further half an hour.

It is then admixed at 90-95° C. with 0.20 g of Borchi® Kat 28 (borchers GmbH) and 15.97 g of Desmodur® I (Bayer AG). It is stirred at 90-95° C. until an isocyanate band is no longer detectable by IR spectroscopy. This gave a highly viscous polyurethane resin pale yellowish in colour.

### Example 12

200 g of polyether V were weighed out under nitrogen into a 1 l glass flask and freed from traces of water by introduction of a stream of nitrogen at 110-115° C. for 1.5-2 hours. This initial charge is cooled to 90° C., admixed with 12.01 g of oleyl-cetyl alcohol (OH number: 181.50 mg KOH/g) and dewatered under a stream of nitrogen for a further half an hour. It is then admixed at 90-95° C. with 0.24 g of Borchi® Kat 28 (borchers GmbH) and 7.77 g of Desmodur® I (Bayer AG). It is stirred at 90-95° C. until an isocyanate band is no longer detectable by IR spectroscopy. This gave a highly viscous polyurethane resin pale yellowish in colour.

The polyurethane thickeners prepared in Examples 1 to 12 were processed to solutions in water with glycols and/or emulsifiers, for example as set out representatively in Table 1 below.

TABLE 1
Formulation examples of the inventive polyurethanes

| | | | |
|---|---|---|---|
| Ex. 13 | PU from Example 3: 25% | Butyl diglycol 16% | Water 59% |
| Ex. 14 | PU from Example 3: 25% | Fatty alcohol | Water 65% |
| | | alkoxylate*) 10% | |
| Ex. 15 | PU from Example 7: 25% | Fatty alcohol | Water 65% |
| | | alkoxylate*) 10% | |
| Ex. 16 | PU from Example 8: 20% | Butyl glycol 12% | Water 68% |
| Ex. 17 | PU from Example 10: 25% | Fatty alcohol | Water 65% |
| | | alkoxylate*) 10% | |
| Ex. 18 | PU from Example 11: 25% | Fatty alcohol | Water 65% |
| | | alkoxylate*) 10% | |
| Ex. 19 | PU from Example 12: 25% | Fatty alcohol | Water 65% |
| | | alkoxylate*) 10% | |

*)Borchers GmbH
The percentages are in each case by weight

### Use Examples

The examples below show that with the inventive thickeners it is possible to thicken aqueous paints, inks and varnishes far more efficiently than with corresponding competitor products.

Production of a model varnish and testing of the thickening effect by viscosity measurement:

### Model Varnish

70.00 g acrylate (Bayhydrol XP 2470)

28.00 g demineralized water

2.00 g butyl glycol

0.05 g Byk 038 (defoamer)

100.05 g

The thickener preparations of Table 1 and also the thickeners set out below in Table 2 were incorporated, each with an active content (polymer fraction) of 0.5%, into 100 g of the above-described model varnish, with the aid of a laboratory stirrer. After an ageing time of approximately 12 hours, the viscosity measurements were carried out at 23° C. in the low-shear range at 1.0 s⁻¹, 10.3 s⁻¹ and 100 s⁻¹, by means of a Haake RS 1 rheometer (measuring elements: cone/plate).

The test results obtained in respect of the thickening effect are set out in Table 2 below.

TABLE 2
Thickening effect of polyurethane thickeners, characterized by the varnish
viscosity achieved
Model varnish; addition of 0.5% PU thickener (based on the active
content)

| | Viscosity in mPas at: | | |
|---|---|---|---|
| | 1 | 10 | 100 |
| | [s-1] | [s-1] | [s-1] |
| Ex. 13 | 4985 | 4373 | 2091 |
| Ex. 14 | 7124 | 5819 | 2233 |
| Ex. 15 | 3976 | 3594 | 1572 |
| Ex. 16 | 2142 | 2018 | 920 |
| Ex. 17 | 7250 | 3780 | 1830 |
| Ex. 18 | 7100 | 4950 | 1920 |
| Ex. 19 | 3870 | 3250 | 1610 |
| Rheolate ® 288 (Elementis) *) | 1346 | 1307 | 856 |
| Tafigel ® PUR 61 (Münzing Chemie GmbH) *) | 1610 | 1572 | 909 |
| Acrysol ® RM 8 W (Rohm & Haas Corp.) *) | 459 | 448 | 386 |
| Acrysol ® RM 825 ((Rohm & Haas Corp.) *) | 671 | 652 | 551 |

*) PU thickeners without a monoalcohol having a carbon-carbon double bond

### SUMMARY

The results of the viscosity measurements show clearly the improved thickening effect of the inventive thickeners in comparison to commercially available products.

1. Water-soluble or water-dispersible polyurethanes prepared in a one-stage or multi-stage chemical reaction, subject to an NCO/OH equivalent ratio of 0.5:1 to 1.2:1, as a reaction product of
A) at least one polyetherpolyol of average functionality≧1.2,
B) at least one (cyclo)aliphatic and/or aromatic diisocyanate,
C) at least one linear or branched, (cyclo)aliphatic monoalcohol having 6 to 34 carbon atoms and at least one unsaturated structural element (carbon-carbon double bond) as an integral constituent or at least one linear or branched, (cyclo)aliphatic monoalcohol alkoxylate having 6 to 34 carbon atoms, at least one unsaturated structural element (carbon-carbon double bond) as a constituent, and having been extended by at least one ethylene oxide (EO) or propylene oxide (PO) unit, or aromatic monoalcohols and/or aromatic monoalcohol alkoxylates having 6 to 34 carbon atoms, or mixtures of these components,
D) where appropriate, a further linear or branched monofunctional component having a carbon radical of 6 to 34 carbon atoms which is able to react with isocyanates and which is preferably composed of a (cyclo)aliphatic and/or aromatic monoalcohol, a (cyclo)aliphatic and/or aromatic monoalcohol alkoxylate or a (cyclo)aliphatic and/or aromatic amine.

2. Polyurethanes according to claim 1, wherein the polyetherpolyol A) has an average functionality of greater than or equal to 2.

3. Polyurethanes according to claim 1, wherein the polyetherpolyol A) has an average functionality of 3 to 4.

4. Polyurethanes according to claim 1, wherein the diisocyanate B) is a (cyclo)aliphatic diisocyanate.

5. Polyurethanes according to claim 1, wherein component C) has 10 to 22 carbon atoms.

6. Polyurethanes according to claim 1, wherein component C) has been chain-extended by reaction with 1-3 mol of alkylene oxide.

7. Polyurethanes according to claim 1, wherein component C) has been chain-extended by reaction with more than 3 mol of alkylene oxide.

8. Polyurethanes according to claim 1, wherein component C) comprises two or more double bonds.

9. Polyurethanes according to claim 1, wherein optional component D) is composed of a linear or branched monoalcohol having 8 to 18 carbon atoms.

10. Polyurethanes according to claim 1, wherein optional component D) is composed of a linear or branched aliphatic amine having 8 to 18 carbon atoms.

11. Process for preparing water-soluble or water-dispersible polyurethanes according to claim 1, wherein, subject to an NCO/OH equivalent ratio of 0.5:1 to 1.2:1, in a one-stage or multi-stage chemical reaction using
A) at least one polyetherpolyol of average functionality≧1.2,
B) at least one (cyclo)aliphatic and/or aromatic diisocyanate,
C) at least one linear or branched, (cyclo)aliphatic monoalcohol having 6 to 34 carbon atoms and at least one unsaturated structural element (carbon-carbon double bond) as an integral constituent or at least one linear or branched, (cyclo)aliphatic monoalcohol alkoxylate having 6 to 34 carbon atoms, at least one unsaturated structural element (carbon-carbon double bond) as an integral constituent, and having been extended by at least one ethylene oxide (EO) or propylene oxide (PO) unit, or aromatic monoalcohols and/or aromatic monoalcohol alkoxylates having 6 to 34 carbon atoms, or mixtures of these components,
D) where appropriate, a further linear or branched monofunctional component having a carbon radical of 6 to 34 carbon atoms which is able to react with isocyanates and which is preferably composed of a (cyclo)aliphatic and/or aromatic monoalcohol, a (cyclo)aliphatic and/or aromatic monoalcohol alkoxylate or a (cyclo)aliphatic and/or aromatic amine,
are reacted with one another.

12. Aqueous or predominantly aqueous systems comprising at least one polyurethane according to claim 1.

13. Method of producing thickened aqueous coating systems, adhesives and other aqueous formulations, by introducing the formulation in question, adding a polyurethane according to claim 1, mixing and ageing the components.
